(19) United States
(12) Patent Application Publication
(10) Pub. No.: US 2026/0254829 A1
(43) Pub. Date: Aug. 27, 2026

(54) Multi-Layered Privacy Protection and Tracking Prevention

(71) Applicant: Zscaler, Inc., San Jose, CA (US)

(72) Inventor: Mitchell Kelly, New South Wales (AU)

(73) Assignee: Zscaler, Inc., San Jose, CA (US)

(21) Appl. No.: 19/065,259

(22) Filed: Feb. 27, 2025

(51) Int. Cl. H04L 9/40

(52) U.S. Cl. CPC H04L 63/1425; H04L 63/0421

(57) ABSTRACT

Systems and methods for cloud-based multi-layered privacy protection and tracking prevention include routing traffic of a plurality of users associated with a tenant of the cloud-based system through a Secure Web Gateway (SWG) of a cloud-based system; analyzing traffic of a user of the plurality of users for privacy threats; employing one or more defense modules to protect the user from the privacy threats based on the analyzing; and monitoring performance of a destination of the traffic to detect performance degradation due to the one or more defense modules.

### FIELD OF THE DISCLOSURE

The present disclosure generally relates to network and cloud security. More particularly, the present disclosure relates to systems and methods for cloud-based multi-layered privacy protection and tracking prevention.

### BACKGROUND OF THE DISCLOSURE

Systems designed to protect users from online tracking, such as ad blockers, privacy-focused browsers, and VPNs, aim to safeguard privacy by preventing data collection on browsing habits. However, these tools face challenges like breaking website functionality, combating evolving tracking methods (e.g., browser fingerprinting), and requiring constant updates. Users often struggle with configuration and understanding, while some tools pose risks by collecting data themselves. Additionally, balancing privacy with the ad-driven internet economy remains a persistent challenge for developers and users alike. Based thereon, the present disclosure presents a cloud-based multi-layered privacy protection and tracking prevention system that solves the described issues.

### BRIEF SUMMARY OF THE DISCLOSURE

The present disclosure relates to systems and methods for cloud-based multi-layered privacy protection and tracking prevention. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include routing traffic of a plurality of users associated with a tenant of the cloud-based system through a Secure Web Gateway (SWG) of the cloud-based system; analyzing traffic of a user of the plurality of users for privacy threats; employing one or more defense modules to protect the user from the privacy threats based on the analyzing; and monitoring performance of a destination of the traffic to detect performance degradation due to the one or more defense modules.

The steps can further include scanning the traffic for known tracking mechanisms and behavioral anomalies utilizing any of signature-based analysis and Artificial Intelligence (AI) and Machine Learning (ML) dynamic analysis. The analyzing can include anticipating, via Artificial Intelligence (AI) and Machine Learning (ML), tracking techniques that do not rely on signatures. The one or more defense modules can include any of Internet Protocol (IP) masking and rotation, browser fingerprinting obfuscation, cookie and local storage management, cross-device and cross-application anonymization, and real-time script blocking. The one or more defense modules can be employed sequentially in a layered approach. The steps can further include temporarily bypassing one or more of the defense modules based on the monitoring. The bypassing can include selectively unblocking essential features of a destination of the traffic to maintain usability. The steps can include allowing an administrator of the tenant to select one or more defense modules to be available for use. The destination can be a website, wherein the monitoring includes identifying issues caused by blocking scripts, altering website behavior, and altering website cookies. The steps can include, based on the monitoring, any of unblocking scripts and restoring website behavior and website cookies.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of an embodiment of the cloud-based multi-layered privacy protection and tracking prevention system.

FIG. 6 is a flowchart of a process for cloud-based multi-layered privacy protection and tracking prevention.

### DETAILED DESCRIPTION OF THE DISCLOSURE

Again, the present disclosure relates to systems and methods for cloud-based multi-layered privacy protection and tracking prevention. Various embodiments are adapted to route user traffic through a Secure Web Gateway of the cloud-based system. Based thereon, the system is adapted to analyze traffic and selectively employ one or more defense modules in order to protect users from tracking and privacy threats. The system is further adapted to perform continuous monitoring of traffic destinations such as websites in order to determine if user experience degradation is occurring due to the various defense modules. Based thereon, the system can selectively disable one or more of the employed defense modules to restore usability while ensuring user privacy is protected.

### § 1.0 CYBERSECURITY MONITORING AND PROTECTION EXAMPLES

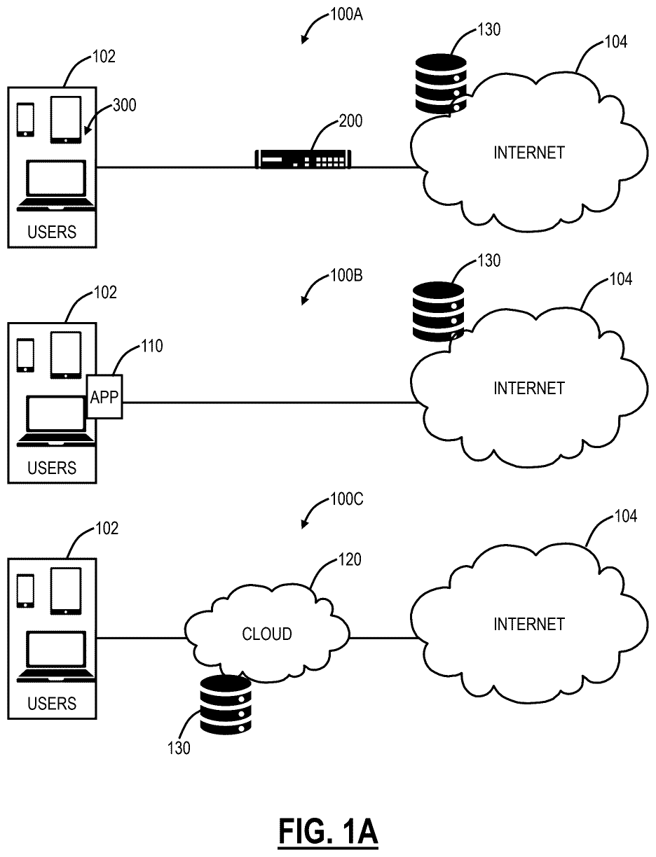

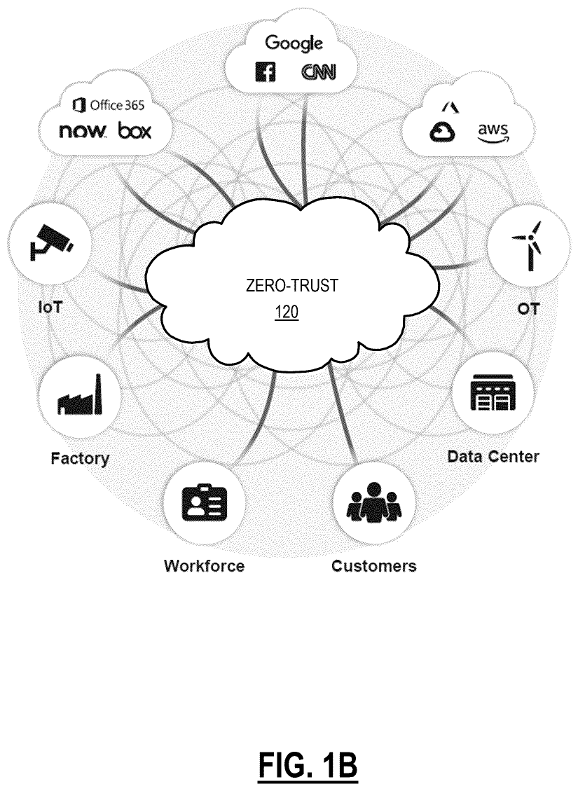

FIG. 1A is a network diagram of three example network configurations 100A, 1001B, 1000 of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

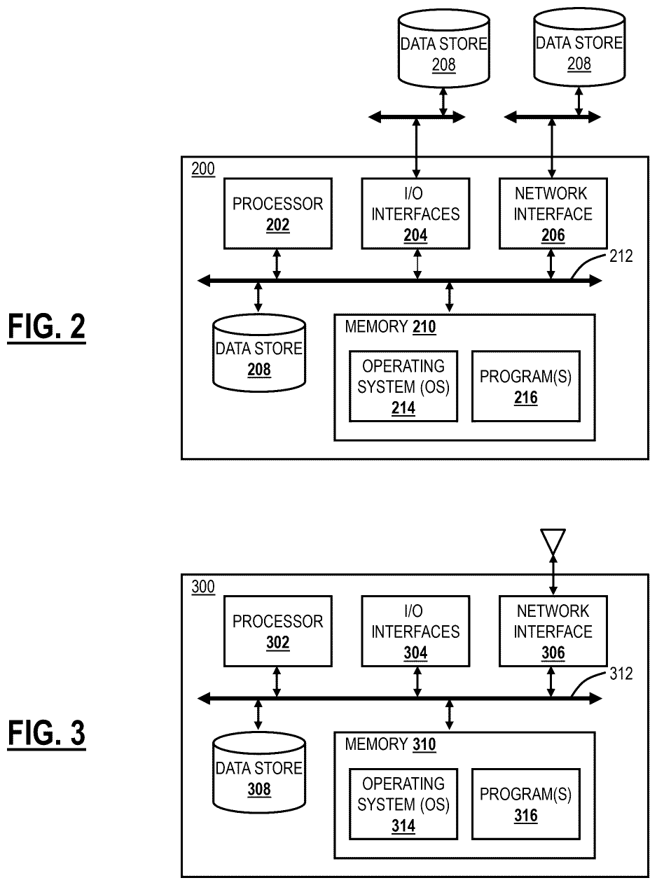

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 1001B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 1000 includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 1000 can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 1000. Also, any of the network configurations 100A, 100B, 1000 can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 1000 can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 1000, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time-before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 1000, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 1000, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 EXAMPLE SERVER ARCHITECTURE

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 EXAMPLE COMPUTING DEVICE ARCHITECTURE

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 APPLICATION FOR TRAFFIC FORWARDING AND MONITORING

Again, the network configuration 100B includes an application 110 that is executed on the computing device 300. The application 110 can perform similar functionality as the server 200, as well as coordinated functionality with the server 200 (a combination of the network configurations 100A, 1001B). Of course, various embodiments are contemplated herein, including combinations of the network configurations 100A, 100B, 1000 together. For example, the application 110 can perform similar functionality as the cloud 120, as well as coordinated functionality with the cloud 120.

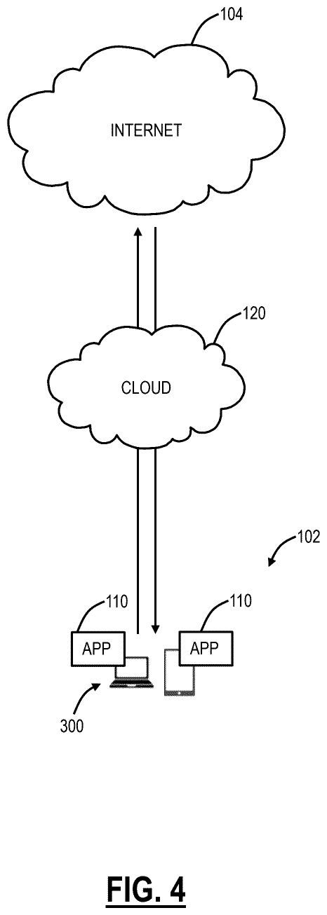

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 MULTI-LAYERED PRIVACY PROTECTION AND TRACKING PREVENTION

The present disclosure presents a cloud-based multi-layered privacy protection and tracking prevention system. In various embodiments, this system is facilitated by the cloud 120 for its tenants via a plurality of modules, engines, etc., executed within servers, virtual machines, etc. associated with the cloud 120. The multi-layered privacy protection and tracking prevention system, further referenced herein as the privacy protection and tracking prevention system, or simply the “system”, is a cutting-edge, cloud-based solution adapted to shield users from a broad spectrum of both basic and sophisticated tracking techniques. This advanced system is engineered to provide comprehensive protection against various forms of online tracking, which include but are not limited to IP address monitoring, browser fingerprinting, cross-device identity resolution, persistent cookies, and behavioral analysis.

At the heart of this innovative solution lies a cloud-based Secure Web Gateway (SWG). This SWG functions as a dynamic shield that anonymizes and obfuscates user interactions in real-time. By doing so, it ensures that the user's privacy is safeguarded at all times without compromising their online experience. The system employs state-of-the-art technologies to intercept and neutralize tracking attempts, thereby maintaining the integrity and confidentiality of the user's digital activities.

One of the standout features of this system is its ability to go beyond the capabilities of conventional privacy tools. Traditional tools often focus on static tracking mechanisms, which can leave users vulnerable to more dynamic and evolving tracking techniques. In contrast, this system is designed to counter both static and dynamic tracking mechanisms effectively. This dual capability ensures that users are protected against a wide range of tracking methods, which are continually evolving in sophistication.

Furthermore, the system provides Privacy-as-a-Service (PaaS), which is a highly customizable and scalable privacy solution. This service model allows users/tenants to tailor their privacy settings according to their specific needs and preferences. Whether the user is operating different devices, utilizing various apps, or engaging in multiple browsing sessions, the system can adapt to provide consistent and robust privacy protection across all contexts. This flexibility makes it an ideal solution for individuals and organizations alike, ensuring that privacy is maintained regardless of the environment or medium of digital interaction.

Additionally, the system's cloud-based architecture offers several advantages. It facilitates seamless updates and enhancements, ensuring that the privacy protection mechanisms are always up to date with the latest advancements in tracking and privacy technology. The cloud infrastructure also allows for scalable deployment, making it suitable for both individual users and large enterprises which utilize the services of the cloud 120.

Essentially, the system represents a significant leap forward in the realm of online privacy. It combines advanced technology, dynamic response capabilities, and a flexible service model to deliver unparalleled privacy protection. Users can navigate the digital world with confidence, knowing that their personal information and online activities are shielded from prying eyes and unauthorized tracking. This solution not only enhances user privacy but also fosters a safer and more secure digital environment for everyone.

The system delivers robust, multi-layered privacy protection by meticulously analyzing, detecting, and neutralizing a wide range of online tracking mechanisms. This sophisticated system seamlessly integrates a powerful privacy engine with an existing cloud-based SWG. By doing so, it is capable of evaluating web traffic in real-time, identifying potential threats, and activating a suite of defensive measures designed to safeguard user privacy.

One of the core functionalities of the system is its ability to implement various privacy-preserving techniques such as IP masking, fingerprinting obfuscation, and cookie management. These techniques work in unison to obscure the user's digital footprint, making it significantly more difficult for trackers to monitor and profile user behavior across the web. IP masking hides the user's actual IP address, preventing geo-location and identity tracking. Fingerprinting obfuscation disrupts attempts to create a unique identifier based on the user's browser and device characteristics, while cookie management controls and limits the use of tracking cookies that can persistently follow users across different websites.

Moreover, the system leverages advanced Artificial Intelligence (AI) and Machine Learning (ML) models to anticipate and counteract new and emerging tracking patterns. This proactive approach ensures that the system is not merely reactive but can also predict and defend against sophisticated tracking techniques before they become widespread. By continuously learning and adapting to the evolving landscape of online threats, the system provides a dynamic and forward-looking privacy defense.

As internet tracking techniques become increasingly sophisticated, existing privacy solutions are struggling to offer adequate protection. Modern tracking methods, such as IP monitoring, browser fingerprinting, persistent cookies, and cross-device tracking, enable the creation of highly detailed user profiles. These profiles can be used for purposes ranging from relatively benign advertising to more malicious activities, raising significant privacy concerns.

Current privacy solutions, including Virtual Private Networks (VPNs), browser plugins, and private browsing modes, typically offer only partial and temporary protection. These tools often fail to address the full spectrum of advanced identity resolution methods that can merge anonymous and identifiable data across multiple platforms. Consequently, users remain vulnerable to sophisticated tracking techniques that can compromise their privacy.

The present system addresses these issues by detecting and neutralizing tracking mechanisms in real-time. This system provides a layered approach to privacy protection, ensuring that users are shielded from a wide range of tracking methods without disrupting website functionality or degrading the user experience. Through its advanced technology, the system offers a more comprehensive and durable solution to the evolving challenges of online privacy protection.

The table below outlines the existing privacy solutions currently available. These solutions encompass a range of tools and technologies designed to protect user privacy online. Each solution offers distinct features and levels of protection, aiming to address various aspects of digital privacy and security.

| Solution | Problem |
|---|---|
| VPN | VPNs provide IP anonymization but fault to |
| | block browser fingerprinting or prevent |
| | persistent cookies. They also often leak |
| | metadata. |
| Browser Plugins | Plugins like uBlock Origin, Privacy Badger |
| | etc. block tracking scripts but may break |
| | website functionality and don't protect |
| | against fingerprinting. |
| Private Browsing Modes | Private Browsing Modes built into the |
| | user's browser, e.g. Incognito Mode, |
| | prevent cookie storage but don't protect |
| | against IP tracking or browser |
| | fingerprinting. |
| Anti-Fingerprinting | Browsers like Brave randomize |
| Browsers | fingerprinting metrics but lack scalability |
| | and comprehensive protection across |
| | devices and apps. They also don't protect |
| | against IP tracking. |

VPNs are one such solution, providing users with the ability to mask their IP addresses and encrypt their internet traffic. However, while VPNs can effectively hide a user's location and encrypt data, they often fall short in protecting against more sophisticated tracking techniques such as browser fingerprinting and cross-device tracking.

Browser plugins and extensions represent another category of privacy tools. These can block ads, prevent tracking scripts from running, and enhance overall browser security. Despite their usefulness, these tools usually offer only partial protection and can sometimes interfere with website functionality, leading to a degraded user experience.

Private browsing modes, available in most modern web browsers, are designed to prevent the storage of browsing history and cookies. While this feature can provide a layer of privacy during a single browsing session, it does not prevent tracking by websites and advertisers, nor does it offer protection against more advanced tracking methods that can link a user's activity across different sessions and devices.

Each of these solutions plays a role in the broader landscape of online privacy protection, yet none provides a comprehensive defense against all forms of tracking. As tracking techniques become more advanced and pervasive, the limitations of these existing tools become increasingly apparent. This underscores the need for more robust and all-encompassing privacy solutions, such as the multi-layered privacy protection and tracking prevention system, which can offer real-time, multi-layered protection without compromising user experience or website functionality.

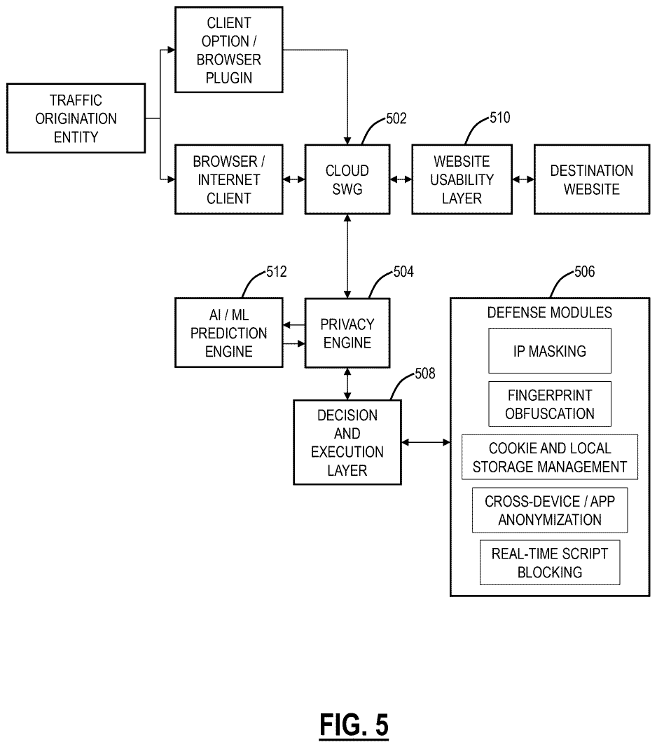

FIG. 5 is a flow diagram of an embodiment of the cloud-based multi-layered privacy protection and tracking prevention system. The system introduces the following key components to overcome the shortcomings of existing solutions.

The cloud-based SWG 502 serves as the foundational element of the system, playing a crucial role in processing all user traffic and delivering essential baseline privacy protection features, such as IP masking and filtering. Acting as a robust intermediary between the user and public Internet sites, the SWG 502 effectively routes traffic through multiple defense layers. This intermediary role is pivotal, as it allows the SWG 502 to intercept and scrutinize all data streams, ensuring that potentially harmful or invasive tracking mechanisms are identified and neutralized before they can reach the user. By anonymizing user interactions and dynamically filtering traffic, the SWG 502 provides a strong first line of defense against a variety of tracking techniques, thereby safeguarding user privacy from the ground up. This comprehensive traffic management and protection mechanism makes the SWG 502 an indispensable component of the system.

The privacy engine 504 is a critical component of the system, responsible for analyzing incoming traffic to detect privacy threats and determine which protective modules need to be activated. This privacy engine 504 operates with a high degree of sophistication, ensuring comprehensive coverage against a wide array of tracking techniques.

One of the key elements of the privacy engine 504 is a threat detection layer. This layer is designed to scan for both known tracking mechanisms and behavioral anomalies using a combination of signature-based (static) and AI/ML-based (dynamic) analysis. The static analysis relies on a database of known threats and behaviors, allowing the system to quickly identify and block traditional tracking methods. In contrast, the dynamic analysis leverages AI and ML to detect and respond to new and evolving threats that may not have established signatures. This dual approach ensures that the system can effectively identify both common and sophisticated tracking techniques.

In addition to the threat detection layer, the privacy engine 504 also includes a tracker pattern recognition component. This element uses advanced AI and ML algorithms to anticipate tracking techniques that do not rely on traditional signatures. By recognizing patterns and behaviors that indicate tracking attempts, this component offers predictive and proactive protection. It can identify emerging threats before they become widespread, enabling the system to block them preemptively.

Together, these components of the privacy engine 504 provide robust and dynamic protection. The threat detection layer ensures that known threats are quickly neutralized, while the tracker pattern recognition component offers a forward-looking defense against new and sophisticated tracking methods. This comprehensive analysis and detection capability is essential for maintaining user privacy in an environment where tracking techniques are continually evolving. The privacy engine 504 thus plays a pivotal role in the overall effectiveness of the multi-layered system.

Once the privacy engine 504 has analyzed the traffic and identified a potential threat, it swiftly activates specific defense modules 506 designed to counteract the identified tracking mechanisms. These defense modules 506 are tailored to address various aspects of tracking and provide comprehensive protection for the user.

One of the key defense modules is IP masking/rotation. This module dynamically changes the user's IP address to prevent long-term tracking based on IP and location data. By frequently rotating the IP addresses, it becomes significantly more difficult for trackers to establish a persistent profile based on the user's online activities.

Another critical module is browser fingerprinting obfuscation. This module obfuscates specific device metrics, such as canvas, WebGL, fonts, audio codecs, and plugin availability. By altering these metrics, the system effectively blocks fingerprinting techniques that attempt to create a unique identifier based on the user's browser and device characteristics.

The cookie and local storage management module plays a vital role in protecting user privacy by blocking or anonymizing persistent cookies and local storage elements. These elements are commonly used by trackers to maintain a long-term record of user behavior across different sessions and sites. By managing these storage mechanisms, the system prevents trackers from gathering and retaining detailed user data.

The cross-device/app anonymization module ensures that data aggregation across multiple devices and applications is impossible. It assigns unique anonymized identifiers for each device and application, preventing trackers from linking activities across different platforms and thus protecting the user's identity and privacy.

Finally, the real-time script blocking module intercepts tracking scripts and pixels before they can load. This proactive measure stops trackers while preserving the functionality of the website. By blocking these scripts in real-time, the system ensures that the user can continue to enjoy a seamless browsing experience without the intrusion of tracking technologies.

Together, these defense modules 506 form a robust barrier against a wide range of tracking techniques. They work in concert to provide layered, dynamic protection that adapts to the evolving landscape of online privacy threats, ensuring that users remain secure, and their personal information stays private.

The decision and execution layer 508 is a vital component of the system, responsible for orchestrating the communication between the privacy engine 504 and the various defense modules 506. This layer ensures that the system operates smoothly and efficiently, effectively responding to detected threats with appropriate defensive measures.

One of the primary actions undertaken by the decision and execution layer 508 is protection activation. Upon receiving information from the privacy engine 504 about a detected threat, the decision and execution layer 508 promptly instructs one or more relevant defense modules to deploy their specific countermeasures. This ensures that the system can immediately respond to threats, minimizing the risk of tracking and data breaches.

In addition to activating initial defenses, the decision and execution layer 508 also controls and manages the protection state. This involves sequentially activating additional layers of protection as necessary to ensure a comprehensive defense strategy. By dynamically adjusting the level of protection in response to the nature and severity of the detected threats, the decision and execution layer 508 maintains a robust and adaptive security posture. This layered defense approach ensures that even if one layer of protection is bypassed, additional defenses remain in place to safeguard user privacy.

Overall, the decision and execution layer 508 plays a crucial role in the system's ability to provide effective and dynamic privacy protection. By managing the activation and coordination of defense modules 506, it ensures that the system can adapt to evolving threats and maintain a high level of security at all times. This intelligent management of defensive resources is essential for delivering the multi-layered protection that users need in an increasingly complex digital landscape.

The website usability layer 510 plays an essential role in maintaining a seamless and functional user experience after the system's defenses have been activated. This layer is designed to monitor the performance of websites to ensure that the activation of privacy protections does not inadvertently disrupt critical website functionality.

A primary function of the website usability layer 510 is error detection. This functionality continuously scans for any issues that may arise from blocking scripts, altering site behavior, or managing cookies and local storage elements. By identifying these issues in real-time, the system can quickly address potential problems that could interfere with the user's ability to interact with the website as intended.

In addition to error detection, the website usability layer 510 includes a fallback or bypass mechanism. This mechanism is crucial for maintaining the balance between privacy protection and usability. When the system detects that certain protective actions are disrupting essential website features, the fallback mechanism temporarily bypasses or selectively unblocks those features. This ensures that users can continue to access and use important website functionalities without interruption. For instance, if a necessary script is blocked, causing a critical feature to malfunction, the system can selectively allow that script to run, thereby preserving the user experience.

This dynamic adjustment capability ensures that the system's robust privacy protections do not come at the cost of usability. By continuously monitoring website performance and making real-time adjustments, the website usability layer 510 helps maintain an optimal balance between security and functionality. This layer is integral to the system's overall design, ensuring that users can enjoy both enhanced privacy and a smooth, uninterrupted browsing experience.

The AI/ML models specifically developed to combat tracking technologies significantly enhance the system's capability to identify and counter new and evolving threats. These advanced models are designed to continuously learn and adapt, drawing insights from a variety of sources including user behavior, emerging threat patterns, and feedback from the usability layer.

By analyzing user behavior, the AI/ML models can discern typical usage patterns and detect deviations that may indicate tracking attempts. This behavioral analysis allows the system to understand the context of user interactions, making it more adept at distinguishing between normal activities and potential threats. Furthermore, these models examine threat patterns, recognizing both known and novel tracking techniques. By identifying commonalities and variations in tracking methods, the models can anticipate and respond to new threats even before they become widely recognized.

Feedback from the website usability layer 510 is also a critical component of the learning process. This feedback loop enables the AI/ML models to refine their predictions and defenses based on real-world performance data. When the system encounters issues that affect website functionality, the usability layer provides insights that help the AI/ML models adjust their strategies to maintain a balance between robust privacy protection and seamless user experience.

Through continuous learning and adaptation, the AI/ML models generate predictions that drive proactive defense measures. This means that the system is not merely reactive, responding to threats as they occur, but is also capable of anticipating and mitigating potential threats before they can impact users. This proactive approach ensures that the system remains effective against the ever-evolving landscape of tracking technologies, providing users with a higher level of privacy and security.

In summary, the AI/ML models are a cornerstone of the system's ability to offer dynamic and forward-looking protection. By leveraging continuous learning from user behavior, threat patterns, and usability feedback, these models enable the system to stay ahead of emerging threats, ensuring comprehensive and proactive defense against tracking technologies.

In various embodiments, a dual-model strategy is employed within the prediction engine to enhance performance and maintain adaptability. This strategy integrates a production model that actively processes real-time traffic and utilizes predictive privacy-protection techniques to safeguard user data. Concurrently, one or more development models are maintained and updated periodically. These development models undergo training with new data that is flagged either by automated system logic, such as data falling within a grey area of confidence where suspicion is high but insufficient for definitive action, or through external mechanisms. External feedback mechanisms may include direct user input, such as a browser plugin that allows users to provide real-time feedback (e.g., thumbs up or thumbs down) on the system's performance or the final rendered page after privacy-protection measures are applied. Additionally, feedback could be sourced from other components within the Secure Web Gateway (SWG) ecosystem, such as indicators from a zero-day detection and response system highlighting excessive round-trip or page-fetch times that may suggest the privacy engine is causing delays due to limited compute resources, bandwidth constraints, or software issues.

To evaluate and compare the efficacy of these models, real-time A/B testing can be conducted by deploying both production and development models simultaneously. Alternatively, testing may leverage a predefined set of known or internally hosted sites specifically curated for model evaluation. If a development model demonstrates significantly better performance, including superior detection and mitigation of privacy threats, it may replace the current production model in an upgrade process. This dual-model framework ensures continuous system improvement by creating a feedback loop that incorporates user insights, automated anomaly detection, and rigorous model testing.

The system offers comprehensive privacy protection by addressing multiple layers of online tracking, providing a holistic solution that surpasses the capabilities of current privacy tools. This multi-faceted approach ensures robust defenses against a wide range of tracking techniques, offering users unparalleled privacy.

Again, the present system is designed to offer comprehensive, real-time protection against a wide variety of tracking techniques. The system performs its functions through a series of coordinated steps, each involving specialized components and layers of defense. In an embodiment, the implementation of the system begins with all user traffic being routed through the cloud-based SWG 502. The SWG 502 serves as the foundational element of the system, providing baseline privacy protection by masking IP addresses and filtering traffic. Acting as an intermediary between the user and public Internet sites, the SWG 502 ensures that all interactions are routed through various defense layers.

Once the traffic passes through the SWG 502, it reaches the privacy engine 504. This engine is responsible for analyzing incoming traffic to detect privacy threats and determine which protective modules need activation. The privacy engine 504 again includes a threat detection layer which scans for known tracking mechanisms and behavioral anomalies using a mix of signature-based (static) and AI/ML-based (dynamic) analysis. The privacy engine 504 further includes tracker pattern recognition which, utilizing AI/ML, anticipates tracking techniques that may not rely on traditional signatures, offering predictive and proactive protection.

Upon detecting a threat, the privacy engine 504 activates specific defense modules 506 to neutralize it. These modules provide tailored protection against various tracking techniques as described herein. The decision and execution layer 508 manages the communication between the privacy engine 504 and the defense modules 506. It instructs the relevant modules to deploy defenses against detected threats and sequentially activates additional layers of protection as needed, ensuring a comprehensive and layered defense approach.

To ensure that the activation of privacy defenses does not disrupt critical website functionality, the website usability layer 510 continuously monitors website performance. This layer is adapted to identify any issues caused by blocking scripts or altering site behavior, cookies, etc., and temporarily bypasses or selectively unblocks essential website features when necessary to maintain usability.

The AI/ML prediction engine 512 plays a crucial role in enhancing the system's ability to identify new and evolving threats. These models continuously learn from user behavior, threat patterns, and feedback from the website usability layer 510 to offer predictions that drive proactive defenses. This continuous learning and adaptation ensure that the system remains effective against emerging tracking techniques.

Designed with enterprise-grade scalability in mind, the system extends the capabilities of existing cloud-based SWGs 502. This scalability allows the system to be deployed across various environments, catering to both individual users and large organizations. By leveraging cloud infrastructure, it ensures that privacy solutions can be adapted and scaled according to the specific needs of any user base, from small teams to global enterprises.

One of the standout features of this system is its modular and customizable nature. Defense modules 506 can be seamlessly integrated into the privacy engine to protect against new and emerging privacy threats. Users or organizations can enable or disable each module based on their preferences or requirements, striking an optimal balance between privacy and usability. This flexibility ensures that the system can evolve with changing privacy landscapes and user needs.

The integration of AI/ML models equips the system to anticipate and defend against future threats. By continuously learning from user behavior, threat patterns, and feedback, the AI/ML models enhance the system's ability to counteract novel and sophisticated privacy invasion and tracking methods. This forward-looking approach ensures that the system remains effective against even the most advanced tracking techniques.

A key objective of the system is to provide a seamless user experience. Designed as an add-on capability to existing cloud SWGs 502, it allows customers to quickly adopt and benefit from the enhanced privacy protections offered by the system. Importantly, it maintains website functionality, ensuring that privacy defenses do not disrupt the user experience. This design philosophy ensures that users receive the highest level of protection without compromising their ability to navigate and interact with websites effectively.

In summary, this system combines comprehensive privacy protection, enterprise-grade scalability, modular customization, AI/ML integration, and a seamless user experience to deliver a state-of-the-art solution for safeguarding online privacy. Whether for individual users or large organizations, it offers a robust, adaptable, and user-friendly approach to privacy protection.

### § 5.1 Multi-Layered Privacy Protection and Tracking Prevention Process

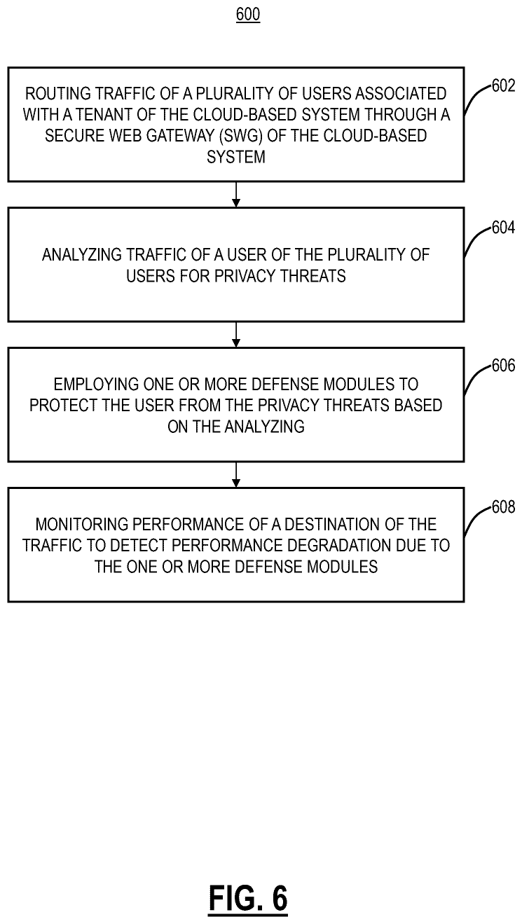

FIG. 6 is a flowchart of a process 600 for cloud-based multi-layered privacy protection and tracking prevention. In various embodiments, the process 600 can be contemplated as a method having steps, a processing device configured to implement the steps, a cloud-based system configured to implement the steps, and as a non-transitory computer-readable medium storing instructions for programming one or more processors to execute the steps. The process 600 includes routing traffic of a plurality of users associated with a tenant of the cloud-based system through a Secure Web Gateway (SWG) of the cloud-based system (step 602); analyzing traffic of a user of the plurality of users for privacy threats (step 604); employing one or more defense modules to protect the user from the privacy threats based on the analyzing (step 606); and monitoring performance of a destination of the traffic to detect performance degradation due to the one or more defense modules (step 608).

The process 600 can further include scanning the traffic for known tracking mechanisms and behavioral anomalies utilizing any of signature-based analysis and Artificial Intelligence (AI) and Machine Learning (ML) dynamic analysis. The analyzing can include anticipating, via Artificial Intelligence (AI) and Machine Learning (ML), tracking techniques that do not rely on signatures. The one or more defense modules can include any of Internet Protocol (IP) masking and rotation, browser fingerprinting obfuscation, cookie and local storage management, cross-device and cross-application anonymization, and real-time script blocking. The one or more defense modules can be employed sequentially in a layered approach. The steps can further include temporarily bypassing one or more of the defense modules based on the monitoring. The bypassing can include selectively unblocking essential features of a destination of the traffic to maintain usability. The steps can include allowing an administrator of the tenant to select one or more defense modules to be available for use. The destination can be a website, wherein the monitoring includes identifying issues caused by blocking scripts, altering website behavior, and altering website cookies. The steps can include, based on the monitoring, any of unblocking scripts and restoring website behavior and website cookies.

### § 6.0 PROCESSING CIRCUITRY AND NON-TRANSITORY COMPUTER-READABLE MEDIUMS

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 7.0 CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner-whether collectively, in subsets, or individually-thereby broadening the range of potential embodiments.

What is claimed is:

1. A method implemented by a cloud-based system, the method comprising steps of:
routing traffic of a plurality of users associated with a tenant of the cloud-based system through a Secure Web Gateway (SWG) of the cloud-based system;
analyzing traffic of a user of the plurality of users for privacy threats;
employing one or more defense modules to protect the user from the privacy threats based on the analyzing; and
monitoring performance of a destination of the traffic to detect performance degradation due to the one or more defense modules.

2. The method of claim 1, wherein the analyzing includes scanning the traffic for known tracking mechanisms and behavioral anomalies utilizing any of signature-based analysis and Artificial Intelligence (AI) and Machine Learning (ML) dynamic analysis.

3. The method of claim 1, wherein the analyzing includes anticipating, via Artificial Intelligence (AI) and Machine Learning (ML), tracking techniques that do not rely on signatures.

4. The method of claim 1, wherein the one or more defense modules include any of Internet Protocol (IP) masking and rotation, browser fingerprinting obfuscation, cookie and local storage management, cross-device and cross-application anonymization, and real-time script blocking.

5. The method of claim 1, wherein the one or more defense modules are employed sequentially in a layered approach.

6. The method of claim 1, wherein the steps further comprise:
temporarily bypassing one or more of the defense modules based on the monitoring.

7. The method of claim 6, wherein the bypassing includes selectively unblocking essential features of the destination of the traffic to maintain usability.

8. The method of claim 1, wherein the steps include allowing an administrator of the tenant to select one or more defense modules to be available for use.

9. The method of claim 1, wherein the destination is a website, and wherein the monitoring includes identifying issues caused by blocking scripts, altering website behavior, and altering website cookies.

10. The method of claim 9, wherein the steps include, based on the monitoring, any of unblocking scripts and restoring website behavior and website cookies.

11. A non-transitory computer-readable medium comprising instructions that, when executed, cause one or more processors of a cloud-based system to perform steps of:
routing traffic of a plurality of users associated with a tenant of the cloud-based system through a Secure Web Gateway (SWG) of the cloud-based system;
analyzing traffic of a user of the plurality of users for privacy threats;
employing one or more defense modules to protect the user from the privacy threats based on the analyzing; and
monitoring performance of a destination of the traffic to detect performance degradation due to the one or more defense modules.

12. The non-transitory computer-readable medium of claim 11, wherein the analyzing includes scanning the traffic for known tracking mechanisms and behavioral anomalies utilizing any of signature-based analysis and Artificial Intelligence (AI) and Machine Learning (ML) dynamic analysis.

13. The non-transitory computer-readable medium of claim 11, wherein the analyzing includes anticipating, via Artificial Intelligence (AI) and Machine Learning (ML), tracking techniques that do not rely on signatures.

14. The non-transitory computer-readable medium of claim 11, wherein the one or more defense modules include any of Internet Protocol (IP) masking and rotation, browser fingerprinting obfuscation, cookie and local storage management, cross-device and cross-application anonymization, and real-time script blocking.

15. The non-transitory computer-readable medium of claim 11, wherein the one or more defense modules are employed sequentially in a layered approach.

16. The non-transitory computer-readable medium of claim 11, wherein the steps further comprise:
temporarily bypassing one or more of the defense modules based on the monitoring.

17. The non-transitory computer-readable medium of claim 16, wherein the bypassing includes selectively unblocking essential features of the destination of the traffic to maintain usability.

18. The non-transitory computer-readable medium of claim 11, wherein the steps include allowing an administrator of the tenant to select one or more defense modules to be available for use.

19. The non-transitory computer-readable medium of claim 11, wherein the destination is a website, and wherein the monitoring includes identifying issues caused by blocking scripts, altering website behavior, and altering website cookies.

20. The non-transitory computer-readable medium of claim 19, wherein the steps include, based on the monitoring, any of unblocking scripts and restoring website behavior and website cookies.
